(19) United States
(12) Patent Application Publication
(10) Pub. No.: US 2026/0010366 A1
(43) Pub. Date: Jan. 8, 2026

(54) FRAMEWORK FOR MODERNIZING APPLICATIONS FOR A CLOUD COMPUTING ENVIRONMENT

(71) Applicant: Rajesh Kamlakar Nerurkar, Charlotte, NC (US)

(72) Inventor: Rajesh Kamlakar Nerurkar, Charlotte, NC (US)

(21) Appl. No.: 18/761,862

(22) Filed: Jul. 2, 2024

(51) Int. Cl. G06F 8/72; G06F 8/65

(52) U.S. Cl. CPC G06F 8/72; G06F 8/65

(57) ABSTRACT

According to some embodiments, systems and methods are provided including retrieving information from an enterprise application data store for a selected first electronic record; based on enterprise application parameters, automatically generating a modernization effort score representing a complexity of modernizing the first application; tagging the first application as one of: a modernization candidate, a re-platform candidate, and a re-host candidate, the tagging based on a comparison of the modernization effort score to a plurality of thresholds; in a case the first application is identified as the modernization candidate: identifying an appropriate cloud computing pattern in the catalogue of cloud computing patterns for the first application; automatically creating, using the identified cloud computing pattern, a reference implementation of the first application; and creating a target modernization template for refactoring the first application, the target modernization template including starter code and structure for the reference implementation. Numerous other aspects are provided.

### TECHNICAL FIELD

The present application generally relates to computer systems and more particularly to computer systems that are adapted to accurately and/or automatically identify applications for modernization with respect to a cloud computing environment.

### BACKGROUND

An enterprise may use applications to perform various tasks. For example, an enterprise application might process business functions associated with customer service, human resources, sales, etc. Typically, such applications were executed using an on-premises computing environment (e.g., various servers, data stores, etc. were hosted on hardware local to the enterprise). Increasingly, however, enterprise applications are migrating to a cloud-based computing environment (e.g., to reduce cost, improve availability, etc.) such as AMAZON® Web Services (“AWS”). As part of the migration process, the enterprise may have to determine whether on-premise applications should be modernized or replaced with an application suitable for a cloud computing environment. Application modernization is the process of updating an existing application to a cloud-first model (“legacy modernization”). Modernization demands during migration may introduce risks associated with re-factoring (“re-writing”) applications using cloud-native services. For example, it may be difficult to guarantee that the changes made as part of re-factoring do not unintentionally introduce issues. Replacing an on-premises application with an application suitable for a cloud computing environment can be a time consuming and difficult task-especially when there are a substantial number of enterprise applications that need to be moved.

It would therefore be desirable to provide improved systems and methods to accurately and/or automatically determine whether an application should be modernized or replaced with respect to migration to a cloud computing environment. Moreover, results should be easy to access, understand, interpret, update, etc.

### SUMMARY OF THE INVENTION

According to some embodiments, systems, methods, apparatus, computer program code and means are provided to accurately and/or automatically determine whether an application available for migration to a cloud computing environment should be modernized, the determination provided in a way that provides fast and useful results and that allows for flexibility and effectiveness when implementing those results.

Some embodiments are directed to an application modernization framework implemented via a back-end application computer server. An enterprise application data store contains electronic records associated with a plurality of enterprise applications, each electronic record including an electronic record identifier and at least one enterprise application parameter. A data repository stores a catalogue of cloud computing patterns. The back-end application computer server is coupled to the enterprise application data store and the data repository, and includes a computer processor, and a computer memory. The computer memory is coupled to the computer processor and stores instructions executable by the computer processor to cause the back-end application computer server to: (i) retrieve information from the enterprise application data store for a selected first electronic record; (ii) based on enterprise application parameters, automatically generate a modernization effort score representing a complexity of modernizing the first application; (iii) tag the first application as one of: a modernization candidate, a re-platform candidate, and a re-host candidate, the tagging based on the modernization effort score; (iv) in a case the first application is identified as the modernization candidate: identify an appropriate cloud computing pattern in the catalogue of cloud computing patterns for the first application; automatically create, using the identified cloud computing pattern, a reference implementation of the first application in a cloud computing environment; create a target modernization template for re-factoring the first application, the target modernization template including starter code and structure for the reference implementation.

Some embodiments comprise: a computerized cloud modernization method implemented via a back-end application computer server, comprising: retrieving, by a computer processor of the back-end application computer server, information from the enterprise application data store for a selected first electronic record; based on enterprise application parameters, automatically generating a modernization effort score representing a complexity of modernizing the first application; tagging the first application as one of: a modernization candidate, a re-platform candidate, and a re-host candidate, the tagging based on a comparison of the modernization effort score to a plurality of thresholds; in a case the first application is identified as the modernization candidate: identifying an appropriate cloud computing pattern in the catalogue of cloud computing patterns for the first application; automatically creating, using the identified cloud computing pattern, a reference implementation of the first application in a cloud computing environment; and creating a target modernization template for refactoring the first application, the target modernization template including starter code and structure for the reference implementation.

In some embodiments, a communication device associated with a back-end application computer server exchanges information with remote devices in connection with an interactive graphical user interface. The information may be exchanged, for example, via public and/or proprietary communication networks.

A technical effect of some embodiments of the invention is an improved and computerized way to accurately and/or automatically determine whether an application should be modernized for migration of the application to a cloud computing environment in a way that provides fast and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of an application modernization framework in accordance with some embodiments.

FIG. 2 illustrates a modernization determination method according to some embodiments of the present invention.

FIG. 3 is table of a non-exhaustive example according to some embodiments of the present invention.

FIG. 4 illustrates a tablet computer display according to some embodiments of the present invention.

FIG. 5 illustrates a model according to some embodiments of the present invention.

FIG. 6 illustrates a tree diagram of a first non-exhaustive example according to some embodiments of the present invention.

FIG. 7 illustrates a tree diagram of a second non-exhaustive example according to some embodiments of the present invention.

FIG. 8 illustrates a model according to some embodiments of the present invention.

FIG. 9 illustrates a method according to some embodiments of the present invention.

FIG. 10 illustrates a chart according to some embodiments of the present invention.

FIG. 11 illustrates a graphical display according to some embodiments of the present invention.

FIG. 12 is a more detailed block diagram of an application modernization framework in accordance with some embodiments of the present invention.

FIG. 13 is a block diagram of an apparatus in accordance with some embodiments of the present invention.

FIG. 14 is a portion of a data store according to some embodiments of the present invention.

FIG. 15 illustrates an administrator display in accordance with some embodiments of the present invention.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data efficiency and usefulness associated with an application modernization framework. The present invention is directed to more than merely a computer implementation of a routine or conventional activity previously known in the industry as it provides a specific advancement in the area of electronic record analysis by providing improvements in the operation of a computer system that facilitates the modernization of enterprise applications for migration to a cloud computing environment. The present invention provides improvement beyond a mere generic computer implementation as it involves the novel ordered combination of system elements and processes to provide improvements in the speed and case of such modernization. Some embodiments of the present invention are directed to a system adapted to automatically identify an application as a candidate for modernization, identifying patterns that can be used to assist the modernization, etc. Moreover, communication links and messages may be automatically established, aggregated, formatted, exchanged, etc. to improve network performance (e.g., by reducing an amount of network messaging bandwidth and/or storage required to implement such modernization, support technological updates, etc.).

As described above, increasingly, enterprise applications are migrating from on-premise computing environments to cloud-based computing environments. Cloud migration may include moving applications, databases, digital assets and services, IT resources, etc. from on-premises to the cloud, either partially or fully. Cloud computing in the form of internet-based cloud services may increase application performance, security, efficiency and scale. In some instances, a new cloud-based application may be bought or built to replace the on-premise application, using the most current technology stack available. In other instances, instead of buying or building a new application, the enterprise may modernize the on-premise application they already have so that the application can be used in the cloud-computing environment. Modernization may include at least one of several strategies.

A rehost strategy (“lift-and-shift”) may transition the application as-is from the on-premise environment to the cloud-based environment (“cloud”) with practically no code changes. While the rehost strategy results in a quickly migrated application, a drawback of the rehost strategy is that it may not be possible to take advantage of all of the benefits (e.g., agility, scalability, etc.) provided by the cloud.

A re-platform strategy includes code changes (e.g., some cloud platform adoption) to the on-premise application so that it can be used with the cloud platform, benefiting from improved scalability and performance of the cloud. With the re-platform strategy, the core architecture of the application remains the same, but has some cloud characteristics like horizontal scaling, performance and portability. The re-platform strategy involves a higher modernization effort than the rehost strategy. A non-exhaustive example of re-platforming is changing the way an application running on OpenShift® container using JBOSS® runtime on-premises is configured so that it can be containerized to run on ECS Fargate® using Tomcat® runtime.

A refactoring strategy includes code changes to allow the application to easily connect and optimally use the cloud. Refactoring includes making changes (“re-architecting”) to existing applications so they can work on the cloud. Refactoring is often used to improve application performance or maintainability or take advantage of cloud-native features. For example, a .NET framework app that runs on Windows is converted into a .NET core so that it can run on a Linux container in ECS Fargate. With refactoring, new code is written for the application to ensure the application will work with the cloud-based server. In some instances, the refactoring strategy may be used for an application that cannot be replaced by a cloud product but is critical and needs optimal performance. The refactoring strategy involves a higher modernization effort than the re-platform strategy. The refactoring strategy may include the use of an alternative application architecture compared to the on-premise application. The refactoring strategy includes breaking down the application components into smaller building blocks and microservices (e.g., core functions), writing new code, as-needed, and wrapping them into containers (e.g., DOCKER® containers) for deployment. The smaller building blocks may improve simplicity.

Two other strategies are a retaining strategy and a retirement strategy. With both of these strategies, the application will not benefit from migration to the cloud. For example, with the retaining strategy, the application is still needed but it is not worth moving the application at this time (e.g., because of compliance issues, migration costs outweighing the benefits, latency requirements, etc.). With the retirement strategy, the application is explicitly phased out as it is not needed any more or the capabilities provided by this application are offered in a redundant manner.

As also described above, enterprises are struggling to modernize applications for cloud migration. In particular, it is challenging for the enterprises to determine when to modernize an application and how to modernize the application (e.g., which strategy to use). Further, modernization may introduce risks associated with refactoring applications using cloud-native services. For example, refactoring involves making significant changes to existing code, which can be a time-consuming process, and may disrupt the development workflow. Additionally, the changes that result from the refactoring may introduce errors or break functionality that was previously working (“bugs”) or introduce regressions to the application that may be resolved with extensive testing, adding to the time and effort involved in the process.

To address these problems, the application modernization framework or system provided by embodiments automatically provides a step-by-step guide on when and how to modernize an application. Embodiments provide reference implementations for modern reference architecture patterns created for common application components of the enterprise encountered during migration. Embodiments further provide for the building of Infrastructure as Code (IaC) and Continuous Integration/Continuous Deployment (CI/CD) pipelines along with implementation of appropriate high availability/disaster recovery (HA/DR) patterns for these reference implementations. Additionally, embodiments may provide a starter kit for each common application component by packaging the IaC, CI/CD workflow, starter code (Hello world implementation) in a GitHub repository into a template and exposing the template on an Internal Developer Portal (IDP) platform to facilitate the developer's modernization and migration of the given application. Embodiments provide for: increased efficiency with respect to a reduced manual effort and faster deployment cycles; cost savings with respect to utilization of cost-optimized migration solutions from the starter kits; and proactive risk mitigation with respect to incorporation of security practices and disaster recovery strategies in the starter kits.

Some embodiments provide for an application assessment whereby the application modernization system assesses the application for cloud readiness, migration risk, value, and compliance with security requirements.

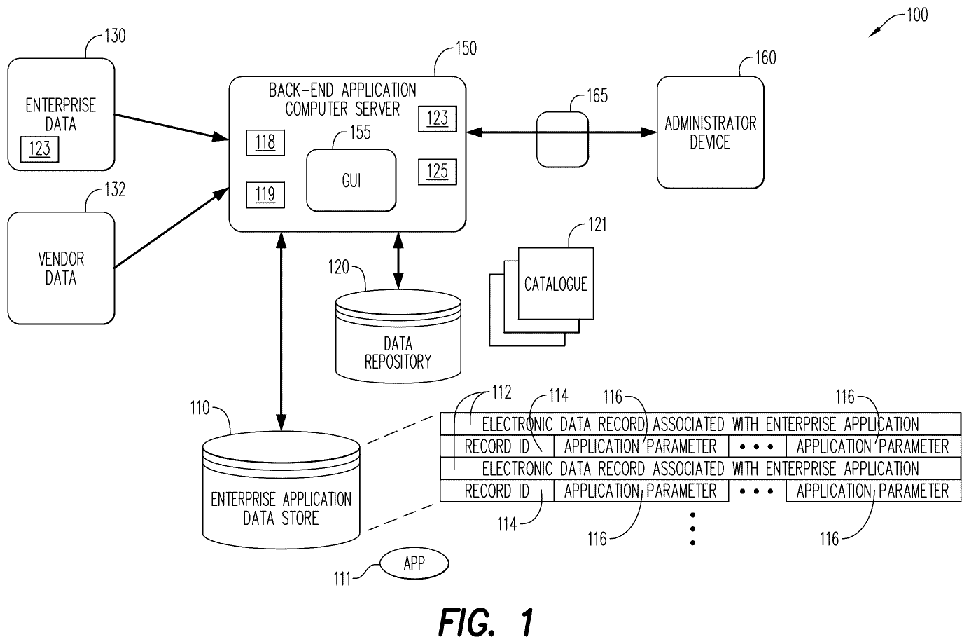

FIG. 1 is a high-level block diagram of an application modernization framework or system 100 according to some embodiments of the present invention. In particular, the system 100 includes a back-end application computer server 150 that may access information in an enterprise application data store 110 (e.g., storing a set of electronic records associated with a set of enterprise applications 112, each record including, for example, one or more record identifiers 114, application parameters 116 such as inputs, outputs, application descriptions, etc.). The back-end application computer server 150 may also exchange information with other data stores (e.g., a data repository 120) and utilize a Graphical User Interface (“GUI”) 155 to view, analyze, and/or update the electronic records. The back-end application computer server 150 may also exchange information with a remote administrator device 160 (e.g., via a firewall 165). According to some embodiments, enterprise data 130 (e.g., information about legacy on-premises application) and/or vendor data 132 may be aggregated and provided to assist with modernization and/or transmitted to the remote administrator device 160. In some embodiments, the remote administrator device 160 may transmit annotated and/or updated information to the back-end application computer server 150. Based on the updated information, the back-end application computer server 150 may adjust data in the enterprise application data store 110, the data repository 120, and/or the change may be viewable via other remote administrator devices. Note that the back-end application computer server 150 and/or any of the other devices and methods described herein might be associated with a third party, such as a vendor that performs a service for an enterprise.

The back-end application computer server 150 and/or the other elements of the system 100 might be, for example, associated with a Personal Computer (“PC”), laptop computer, smartphone, an enterprise server, a server farm, and/or a database or similar storage devices. According to some embodiments, an “automated” back-end application computer server 150 (and/or other elements of the system 100) may facilitate the automated access and/or update of electronic records. As used herein, the term “automated” may refer to, for example, actions that can be performed with little (or no) intervention by a human.

As used herein, devices, including those associated with the back-end application computer server 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the enterprise application data store 110 and the data repository 120. The data store 110 and data repository 120 may be locally stored or reside remote from the back-end application computer server 150. As will be described further below, the enterprise application data store 110 may be used by the back-end application computer server 150 in connection with an interactive modernization interface to access and update electronic records. Although a single back-end application computer server 150 is shown in FIG. 1, any number of such devices may be included. Moreover, various devices described herein might be combined according to embodiments of the present invention. For example, in some embodiments, the back-end application computer server 150 and enterprise application data store 110 might be co-located and/or may comprise a single apparatus and/or be implemented via a cloud-based computing environment.

The information in the enterprise application data store 110 may represent a plurality of applications (“apps”) that may need to be migrated to a cloud computing environment. According to some embodiments, the system 100 may automatically identify a given application as a modernization candidate. This might be based on, for example, an automatically generated modernization effort score. The modernization effort score, may, in turn, be based on an output of an application complexity assessment tool 118 that analyzes factors including, but not limited to, an application architecture, an application life cycle management, an application complexity and inconsistency, integration points, data persistence and non-functional requirements. Moreover, the data repository 120 may contain a catalogue 121 of patterns that can be used along with a reference implementation to create a target state solution for converting the application tagged as a modernization candidate from an on-premise application to a cloud-based application. The target state solution is the framework that provides the shifts and changes needed to refactor the application.

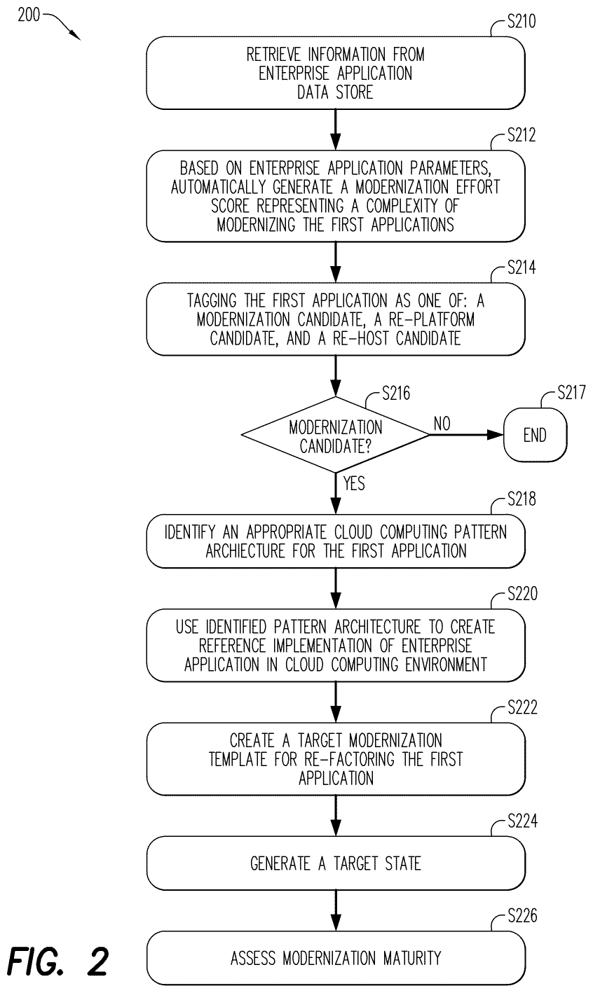

Note that the system 100 of FIG. 1 is provided only as an example, and embodiments may be associated with additional elements or components. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

Prior to the method 200, an application (“app”) 111 is selected as a candidate for migration. Pursuant to some embodiments, the application 111 may be represented by a link or other icon on a graphical user interface. Selection of the application (e.g., by touchscreen or computer mouse pointer) may cause the system or platform to initiate the method 200.

At S210, the back-end application computer server 150 may retrieve information from an enterprise application data store 110 for the selected application 111. The enterprise application data store 110 contains electronic records associated with enterprise applications. Each electronic record might include, for example, an electronic record identifier and at least one enterprise application parameter. The enterprise applications associated with the records in the enterprise application data store might be associated with, for example, on-premises applications, legacy applications, etc.

Based on enterprise application parameters 116, an application complexity assessment tool 118 of the back-end application computer server 150 automatically generates a modernization effort score at S212. The modernization effort score represents a complexity of modernizing the selected application. As described above, for example, the refactoring strategy for an application is more complex than the re-platform strategy, which in turn is more complex than the re-host strategy. The complexity may be based on an evaluation of data points related to altering the application to match the cloud environment. The modernization effort score may gauge the degree to which the application can be produced and operated in the cloud environment. The data points may include, but are not limited to, build automation and artifacts, test automation and artifacts, presence of source control, evidence of observability, overall code structure (e.g., modularization, size project layout, etc.) and evidence of deployment readiness (e.g., versioning, containerization, etc.).

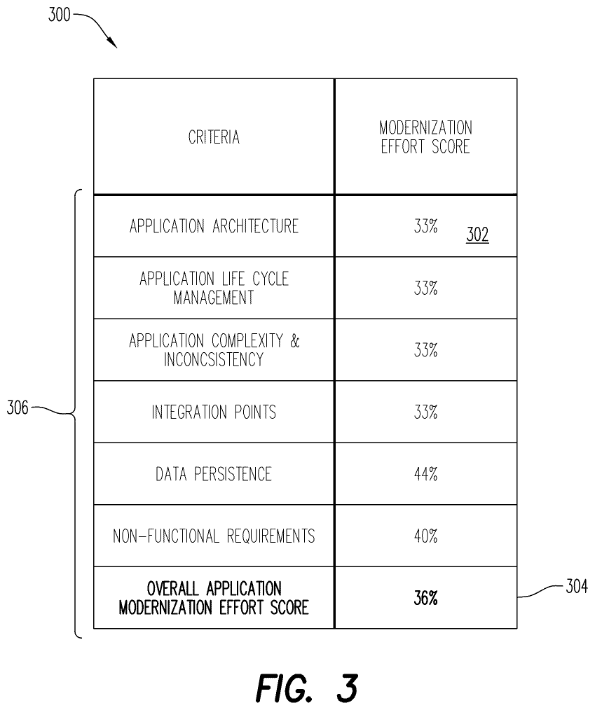

According to embodiments, an overall modernization effort score 304 (FIG. 3) may be an average of a plurality of modernization effort scores calculated for a respective plurality of criteria 306 (FIG. 3). The criteria 306 include, but are not limited to, application architecture, application life cycle management, application complexity and inconsistency, integration points, data persistence, and non-functional requirements. As shown in FIG. 3, a table 300 includes the overall modernization effort score 304 of 36%, and is an average of modernization scores 302 of 33%, 33%, 33%, 33%, 44% and 40% for the application architecture, application life cycle management, application complexity and inconsistency, integration points, data persistence, and non-functional requirements criteria, respectively. The scores for each criterion may be affected by, as a non-exhaustive example, a number of occurrences of data points indicating the feature.

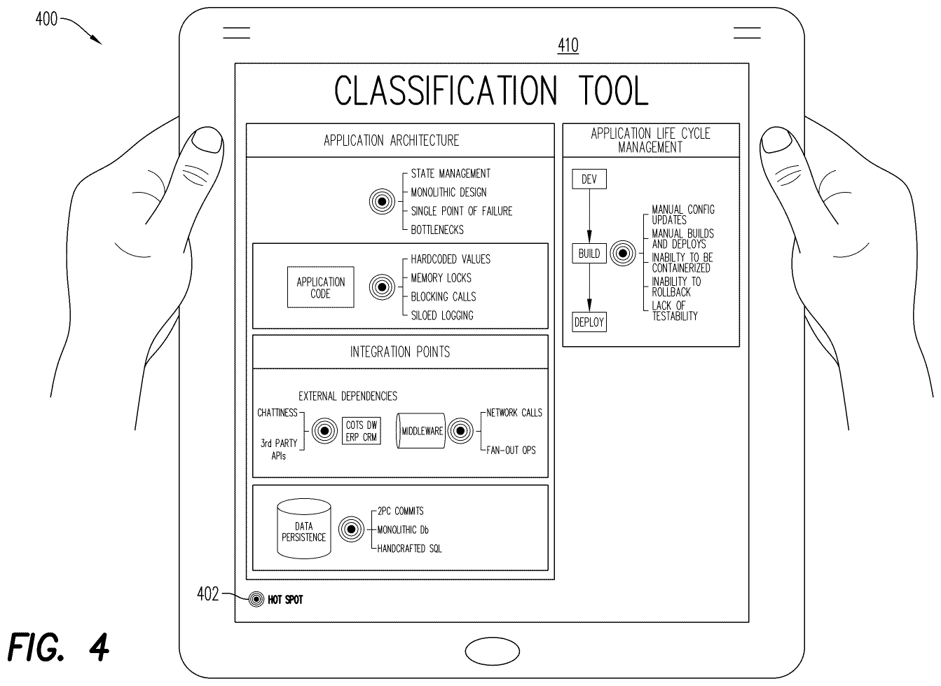

Each criterion 306 may include one or more elements (“hot spots”) 402 that may have a greater weight in the determination of the modernization effort score as compared to other elements. As a non-exhaustive example, FIG. 4 illustrates a tablet computer 400 with an Effort Score Hot Spot Display 410 according to some embodiments. It is noted that displays and devices illustrated herein are only provided as examples, and embodiments may be associated with any other types of user interfaces. The Effort Score Hot Spot Display 410 includes Application Architecture criteria, Integration Points criteria, Data Persistence criteria and Application Life Cycle criteria, each with one or more hot spots 402. For example, the hot spots within the Application Architecture criteria are state management, monolithic design, single point of failure and bottlenecks. The Application Architecture criteria also includes the hot spot “Application Code”, which in turn has sub-elements of hardcoded values, memory locks, blocking calls, and siloed logging. The hot spots 402 within the Integration Points criteria are external dependencies of Commercial Off The Shelf (COTS) Data Warehouse (DW) Enterprise Resource Planning (ERP) Customer Relationship Management (CRM) and Middleware. COTS DW ERP CRM has sub-elements of chattiness and third party APIs. Middleware has sub-elements of Network Calls and Fan-Out Ops. The hot spots 402 within Data Persistence are 2PC commits, Monolithic database, Handcrafted SQL. The Application Life Cycle criteria includes a development phase, a build phase and a deploy phase. The hot spots 402 within the Application life Cycle are Manual configuration updates, manual builds and deploys, an inability to be containerized, an inability to rollback and a lack of testability.

Next, in S214, the selected application is tagged as one of: a modernization candidate, a re-platform candidate, and a rehost candidate. The tagging is output by an application modernization prioritization model 119. The tagging may be stored in the appropriate data store. Pursuant to embodiments, the application modernization prioritization model 119 may receive the overall modernization effort score 304 as input. The modernization effort score may be directly and automatically received from the application complexity assessment tool 118. The application modernization prioritization model 119 may also receive an enterprise objective value 123 from the enterprise data. The enterprise objective value 123 is an indication of how closely the application is strategically aligned with enterprise objectives. As a non-exhaustive example, consider a case where the application offers capabilities that are provided by a more modern application that was implemented recently and is used by more users. In this case, the application may not be strategically aligned with enterprise objectives. As another non-exhaustive example, consider a case where an application is in-house developed and provides crucial enterprise capabilities, and an off-the-shelf application is not readily available. In this case, the application may be highly strategically aligned with enterprise objectives.

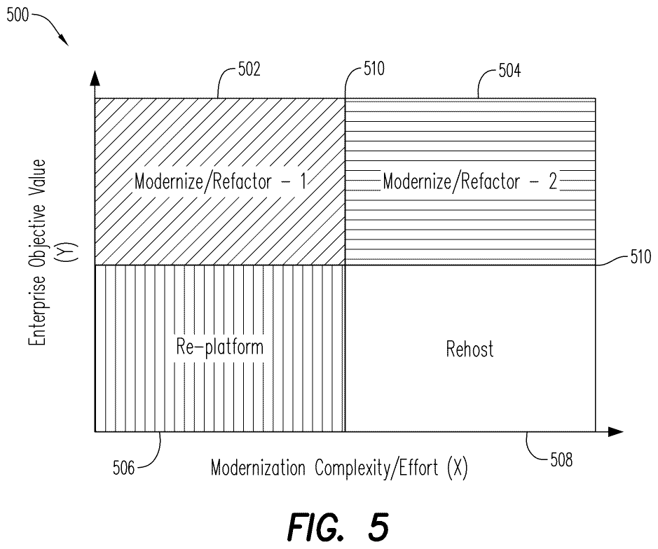

FIG. 5 displays a chart 500 representing the application modernization prioritization model 119. The chart 500 includes four quadrants 502, 504, 506, 508, with thresholds 510 provided for each quadrant. The first quadrant 502—Modernize-Re-factor-1—describes applications with a high enterprise objective value and low complexity, such that the application is strategically aligned with enterprise objectives and the application is easier to change/modernize to: enhance the user experience, lower costs, increase revenue, increase market share or enable entering a new market. For applications falling within the thresholds of the first quadrant 502, the application modernization prioritization model 119 recommends applications in this category to receive top priority for re-factoring/re-writing to receive the benefits of the cloud native capabilities. The second quadrant 504—Modernize-Re-factor-2—describes applications with a higher enterprise objective value and high complexity, such that the application is strategically aligned with the enterprise objectives, and the application is hard to change/modernize to: enhance user experience, lower costs, increase revenue, increase market share or enable entering a new market. For applications falling within the threshold 510 of the second quadrant 504, the application modernization prioritization model 119 recommends applications in this category for re-factoring/re-writing and to break the modernization effort into smaller, incremental deliverables to reduce costs or reduce risks. The third quadrant 506—Re-platform—describes applications with a lower enterprise objective and lower complexity, such that the application is not strategically aligned with the enterprise objectives, and the application is easier to change, but does not enhance user experience, lower costs, increase revenue, increase market share or enable entering a new market. For applications falling within the threshold 510 of the third quadrant 506, the application modernization prioritization model 119 recommends re-platforming these applications to cloud-ready technology stacks and capabilities, since the goal is to maximize value with limited number of resources. The fourth quadrant 508—Rehost—describes applications with a lower enterprise objective and higher complexity, such that the application is not strategically aligned with the enterprise objectives and the application is hard to change (e.g., legacy vendor platform) and does not enhance the user experience, lower costs, increase revenue, increase market share or enable entering a new market. For applications falling with the thresholds 510 of the fourth quadrant 508, the application modernization prioritization model 119 recommends rehosting these applications since the intent of the application is to continue use. Any dependency on these applications may need to be remediated post migration.

Turning back to the method 200, after the application is tagged, in S214, it is determined in S216 whether the application is a modernization candidate based on the tagging. In the case the application is tagged as the re-platform candidate or the rehost candidate, it is not a modernization candidate and the process ends at S217. In the case the application is tagged as the modernization candidate, the process continues to S218 and an appropriate cloud computing pattern is determined for the application.

For a given enterprise, any on-premises application may be a valid combination of any of two or more component types, packaged and deployed as components of the application. The combination of two or more component types may be referred to herein as a “pattern”. The patterns may be stored in a catalogue of cloud computing patterns stored at a data repository. As a non-exhaustive example, the application may be a combination of any of the following component types: single page application (“SPA”) (e.g., an application using Angular JS), multi-page application (“MPA”) (e.g., an application using Spring/Spring Boot for web deployment), standalone batch job (e.g., an application without a user interface for batch processing), data pipeline (e.g., an application without a user interface to manage data transfer across applications within a cloud environment and/or between an internal environment and a vendor), headless monolith (API Interface) (e.g., an application without a user interface that exposes an API for consumption by a client), and headless monolith (messaging interface) (e.g., an application without a user interface that works as a product and/or consumer for asynchronous messaging). Non-exhaustive examples of patterns include serverless architecture patterns, event driven architecture (EDA) patterns and microservices architecture patterns. The serverless architecture pattern may involve running the application on a serverless platform. The serverless architecture pattern may reduce operational complexity and cost (e.g., Single Page App pattern that uses S3 for storing static content and ECS Fargate or Lambda as Backend for Frontend). The event driven architecture pattern may involve designing the application so that components produce or consume events, making the application more scalable and resilient (e.g., cloud-native or hybrid Event Driven Architecture patterns that use SNS/SQS/EventBridge to send/receive events from/to producer/consumer). The microservices architecture patterns may include, for example, three sub-patterns: a strangler pattern, an outbox pattern and a saga pattern. The strangler pattern is a method for gradually replacing a legacy system by implementing new functionality and routing the requests to the new system, eventually “strangling” the old system until it's no longer necessary. The outbox pattern ensures data consistency in microservices by storing events in an outbox table before they are relayed to other services or systems. The outbox pattern provides a safety net for data during network issues or service downtime. The saga pattern is a sequence of local transactions across multiple microservices to maintain data consistency. If a step fails in the saga pattern, compensating transactions are executed to maintain data integrity.

The patterns might be associated with an integration type, an inbound flow direction, an outbound flow direction, foundational patterns, primitive patterns, guardrail patterns, etc. The identification in S218 may be via analysis of a decision tree provided for each component. It is noted that while a decision tree is provided herein for the single page application component and the multi-page application component, this is for brevity and decision trees are provided for each component. Further, the identification may be based at least in part on characteristics of the application, and there may be multiple patterns that are included for a given component type based on the characteristics. The decision tree may provide two or more branches to instruct the system which pattern to select, with each branch leading to a particular recommended pattern.

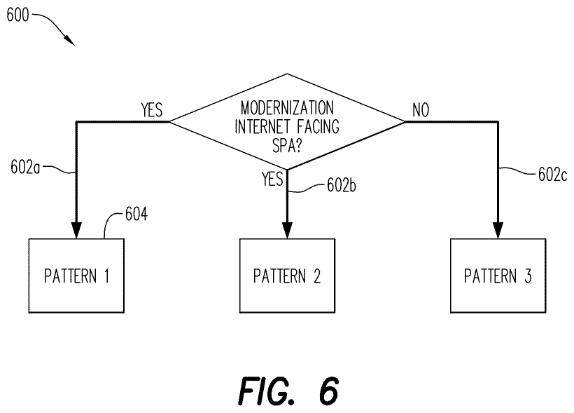

Continuing with the non-exhaustive example of the decision tree 600 for the single page application in FIG. 6, there are three branches 602 a, b, c dependent on the question of whether the modernizing is of an internet facing SPA. For the first branch 602a, the modernizing is of an internet facing SPA, and the transition state pattern hosts external SPA dynamic content on a cloud, but incurs reverse demand of having a web server with a ForgeRock Web agent and static content on-prem. For this first branch, the use pattern maps to pattern identifier 604 of Pattern 1 (e.g., “SPA_External_Pattern1”). For the second branch 602b, the modernizing is of an internet facing SPA, and for an application closest to the target state, this transition state pattern hosts static content for External SPA on S3 and directs application requests through EdgeMod Ingress guardralla in cloud. For this second branch, the use pattern maps to pattern identifier 604 of Pattern 2 (e.g., “SPA_External_Pattern2”). For the third branch 602c, the SPA is not for modernizing an internet facing SPA, and the transition state pattern modernizes end-user authentication for Internal SPAs using Azure AD and receives all traffic for the application through EdgeMod guardralla in cloud. For this third branch, the use pattern maps to pattern identifier 604 of Pattern 3 (e.g., “SPA_Internal_Pattern3”. The patterns may further include integration patterns to design end-to-end functionality in a case the storage and database are applicable to this application.

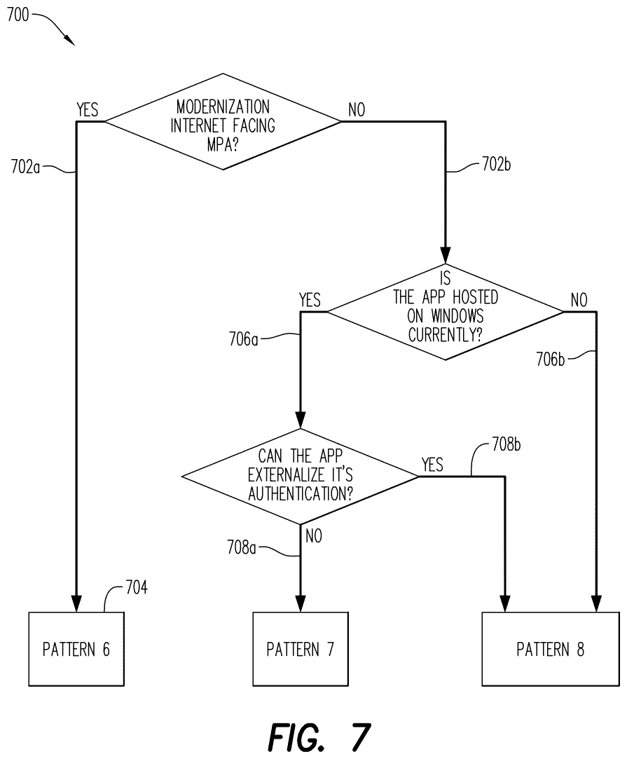

As another non-exhaustive example of the decision tree 700 for the multi-page application in FIG. 7, there are two initial (parent) branches 702 a, b. These two initial branches are dependent on the answer to the question of whether the modernizing is of an internet facing MPA.

For the first branch 702a, the modernizing is of an internet facing MPA, and the transition state pattern hosts External MPA on the cloud, but incurs reverse demand of hosting a web server on-prem to manage end-user Authentication using ForgeRock Web agent. This first branch maps to a use pattern with a pattern identifier 704 of Pattern 6 (e.g., “MPA_External_Pattern6.”

For the second branch 702b, the modernizing is not of an internet facing MPA, and the transition state pattern hosts internal MPA on cloud and modernizes end-user authentication to Azure AD. An extent of modernization achieved is dependent on the application's ability to externalize its authentication process. This second branch 702b includes a plurality of sub-branches (children branches) dependent on the question of whether the application is currently hosted on Windows.

For the first child branch 706a, the application is currently hosted on Windows. This child branch 706a drills down to two grandchild branches 708 a,b dependent on the question of whether the application can externalize its authentication. In a case the application cannot externalize its authentication, this means the application uses Kerberose based authentication against on-premises AD in current state, and does not plan to modernize its authentication method in the cloud. For this grandchild branch 708a, the pattern describes a non-modernization solution, and is contained for further use. Use of this pattern lowers the application's modernization score and incurs a technology debt. The pattern identifier 704 in this case may be Pattern 7 (e.g., “MPA_Internal_Pattern7”).

In a case the application can externalize its authentication per the second grandchild branch 708b, it means that the application uses Kerberos based authentication against on-premises AD in the current state, but the application will modernize and use Azure AD as its IdP in the cloud. For this grandchild branch, the pattern identifier 704 may be Pattern 8 (e.g., “MPA_Internal_Pattern8”.

Turning back to the second branch 702b, and the question of whether the application is currently hosted on Windows, for the second child branch 706b, the application is not currently hosted on Windows. For this child branch the pattern identifier 704 may also be Pattern 8 (e.g., “MPA_Internal_Pattern8”).

With respect to the other components, decision trees may include, but are not limited to, decisions as follows: for the standalone batch job, decisions about whether the batch jobs are currently hosted on Windows, whether the batch jobs can be containerized to run on Linux Servers, and whether there is modernizing batch jobs with advanced scheduling needs and/or ones dependent on on-prem jobs; for the data pipeline, decisions about whether the modernization is of an on-going data integration between applications; for the headless monolith (API Interface), decisions about whether the modernizing is of APIs accessed by internal applications; and for headless monolith (messaging interface), decisions about whether the modernizing is an event based integration with both event producer and consumer applications on the cloud, and whether modernizing of event based integration is with applications on-premises.

The system may use the identified cloud computing pattern (e.g., a reference architecture pattern) to automatically facilitate creation of a reference implementation for the enterprise application in a cloud computing environment at S220. The identified cloud computing patterns may determine the modern technology stack for the application components, as well as the corresponding reference architecture pattern to use, as described above, via the pattern identifier. The reference architecture may provide structures and respective elements and relations to keep in mind as the application is refactored. The reference architecture pattern describes what to build, but not how to implement it. To address this, embodiments provide a reference implementation showing how to construct/implement the pattern. The reference implementation (“framework”) may be a code/program that implements the requirements for the corresponding pattern. Together, the reference architecture pattern and the reference implementation may create a target modernization template 125 in S222 for re-factoring the application. As described above, the target modernization template 125 includes starter code and structure for the reference implementation. Pursuant to embodiments, the reference implementation provides the following for each application component (e.g., single page application, multi-page application, data pipeline, standalone batch job, headless monolith API interface, and headless monolith messaging interface): (i) IaC template and IaC pipeline to provision the infrastructure for the component, (ii) Hello World app and DevSecOps pipeline to deploy the Hello World app on to the provisioned infrastructure, and (iii) an IDP template packaging items (i) and (ii) with customizable parameters on the IDP Portal.

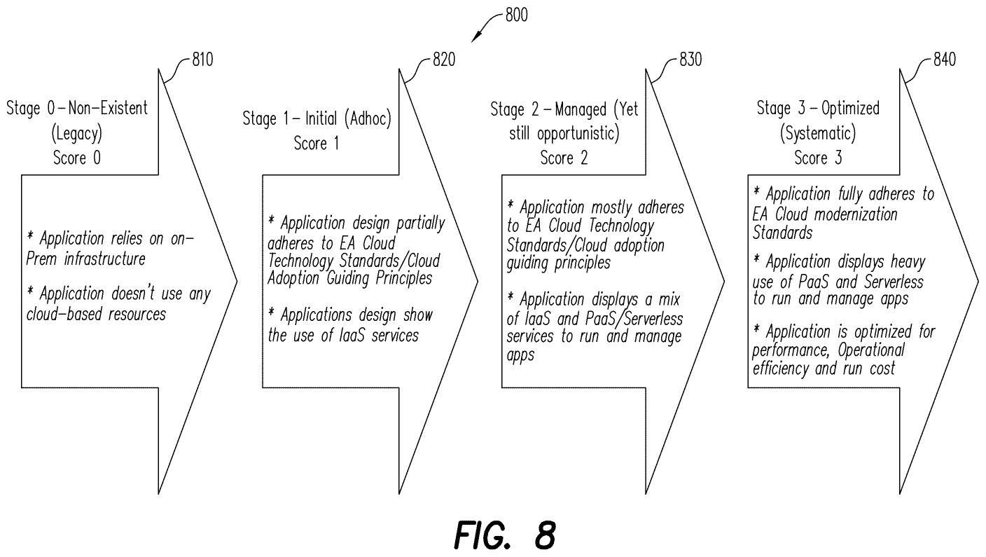

Next, in S224, a target state is generated for refactoring. The target state may be generated using the target modernization template 125. Then in S226, modernization maturity may be assessed by scoring the target state using a modernization scoring model 800 (FIG. 8). The scoring output by the modernization scoring model 800 may be one of: Assigned Score of Zero for Stage 0 (810)—Non-Existent (Legacy); Assigned Score of One for Stage 1 (820)—Initial (Adhoc); Assigned Score of Two for Stage 2 (830)—Managed (Yet still opportunistic); and Assigned Score of Three for Stage 3 (840)—Optimized (Systematic). The modernization scoring model 800 may base the score on one or more criteria including, but not limited to, application design, database design, storage design, and process automation.

Pursuant to embodiments, the application design criteria for Stage 0 may apply to application components that are designed using traditional or legacy architectures and tools that are not optimized for the cloud (e.g., multi-page application architecture, use of VMs). The database design criteria for Stage 0 may apply to applications using traditional or legacy databases and/or data warehouses that are not optimized for the cloud e.g., Oracle on EC2. The storage design criteria for Stage 0 may apply to applications using traditional or legacy storage solutions such as on-premises Network Attached Storage (NAS) that are not optimized for the cloud. The process automation criteria for Stage 0 may apply to applications that do not have any specific tools or platforms to automate, orchestrate, monitor and optimize their processes in the cloud (e.g., manual provisioning of the infra and applications using scripts/Command Line Interface (CLI)).

The application design criteria for Stage 1 may apply to applications having components that are designed using some cloud-native architectures and services, but rehosted or re-platformed without significant changes (e.g., rehosting multi-page applications on EC2 with Windows AD join). The database design criteria for Stage 1 may apply to applications using some cloud-based databases and/or data warehouses that suit their needs and preferences by mostly rehosting or re-platforming their data without significant changes (e.g., Oracle on EC2® and Oracle RDS®). The storage design criteria for Stage 1 may apply to applications using some cloud storage solutions that suit their needs and preferences but mostly rehost or re-platform using similar technologies in the cloud without significant changes such as FSx or EFS. The process automation criteria for Stage 1 may apply to applications having basic tools or platforms to automate, orchestrate, monitor and optimize their processes in the cloud, but they are not consistent or comprehensive (e.g., manual provisioning of infrastructure using scripts/CLI and a basic CLI/CD pipeline to perform build and employment with no security or quality scanning tools embedded in the pipeline.)

The application design criteria for Stage 2 may apply to applications having components using a mix of cloud-native architectures and services, such as serverless environments and containerization, and refactored/rearchitectured applications to leverage the cloud benefits (e.g., refactoring MPA to run on ECS Fargate while still running Batch jobs on EC2). The database design criteria for Stage 2 may apply to applications using a mix of cloud-based databases and/or data warehouses that suit their needs and preferences and refactoring/rearchitecturing some of their data to leverage the cloud benefits (e.g., Aurora PostgreSQL & Oracle RDS). The storage design criteria for Stage 2 may apply to applications using a mix of cloud storage solutions that suit their needs and preferences and applies that refactor/rearchitect/rewrite to some of their storage design to leverage cost effective storage such as S3 along with FSx or EFS. The process automation criteria for Stage 2 may apply to applications having some advanced tools or platforms to automate, orchestrate, monitor and optimize their processes in the cloud, such as CI/CD and DevOps practices, but they are not fully integrated or standardized (e.g., automated infrastructure and application provisioning using a mix of stacks to implement the IaC and CI/CD pipeline like a combination of CodePipeline and Jenkins/Terraform Pipeline with security and quality scanning embedded into the pipeline).

The application design criteria for Stage 3 may apply to applications having components using only cloud-native architecture and services, such as microservices and event-driven architectures using serverless services and applications that are refactored or rearchitectured to leverage the cloud benefits (e.g., rearchitecturing an MPA into an SPA and running it on ECS Fargate and refactoring a batch job and containerizing it to run on AWS Batch or rewriting it in AWS Gluc). The database design criteria for Stage 3 may apply to applications using only cloud-based databases and/or data warehouses that suit their needs and preferences and applications refactoring/rearchitecturing/rewriting or building new data to leverage the cloud benefits (e.g., Aurora PostgreSQL or Aurora Serverless only). The storage design criteria for Stage 3 may apply to applications using only cost-effective cloud storage solutions, such as S3, that suit their needs and preferences and refactoring/rearchitecturing/rewriting all their storage design accordingly. The process automation criteria for Stage 3 may apply to applications having some advanced tools or platforms to automate, orchestrate, monitor and optimize their processes in the cloud, such as CI/CE and DevOps practices, and they are fully integrated or standardized (e.g., automated infrastructure and application provisioning using a single standard stack to implement the laC and CI/CD pipeline like GitHub actions with security and quality scanning embedded into the pipeline).

Prior to creation of the reference implementation, identification of the pattern may result in creation of a demand (e.g., a work ticket) and a team. The team might be associated with, for example, a solution architecture, security, a technology delivery manager, etc. According to some embodiments, approvals may be sought. The approvals might be associated with, for example, the logical and/or physical design of the application (e.g., in connection with an architecture assurance review for strategic alignment and design quality). Other examples of approvals include a security assessment and rating, a disaster recovery plan, risk acceptance or mitigation plans, automated provisioning (e.g., using pipelines), review by a change request board, a permit to operate a tollgate for operational readiness, etc.

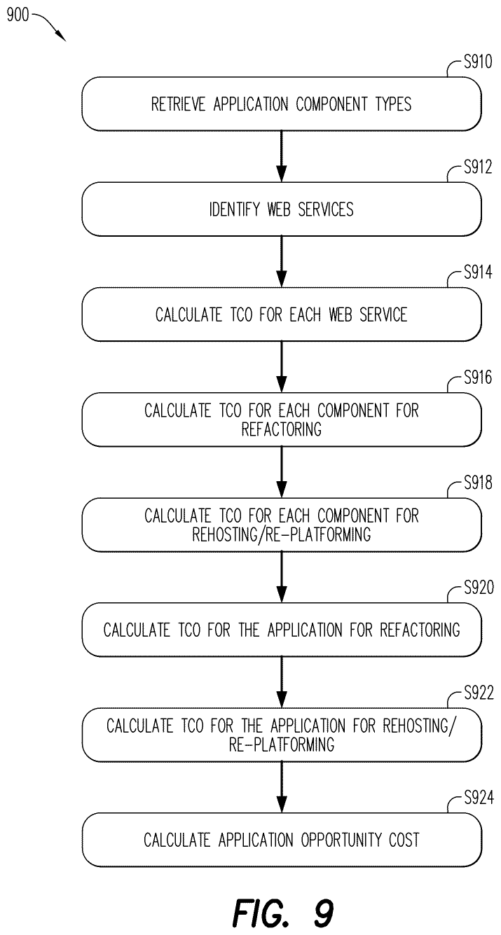

In some instances, while the application is tagged as a modernization candidate in S214, an analysis for refactoring vs rehosting/re-platforming the application may be generated by the system at FIG. 9. For example, the cost of refactoring at this time may be too great, or there may be a question as to how customer identity and access management (CIAM) will be executed in the cloud environment.

FIG. 9 is a refactoring vs rehosting/re-platforming analysis process 900 that is performed in a case the application is marked for further analysis. In some embodiments, the application may be marked with a “refactoring-rehosting/re-platforming” flag indicating the analysis is to be performed in a case the application is tagged as a modernization candidate. This is a non-exhaustive example, and the application may be otherwise marked to perform the analysis process 900. The analysis process 900 may estimate the implementation effort for both options. Pursuant to some embodiments, the analysis process 900 may calculate a Total Cost of Operation (TCO) for refactoring vs. rehosting/re-platforming options over the next four to five years and compare the cost for refactoring vs. rehosting/re-platforming options to show the value of the refactoring (modernization). While the example analysis herein is shown with respect to four to five years, other measures of time may be used for comparison.

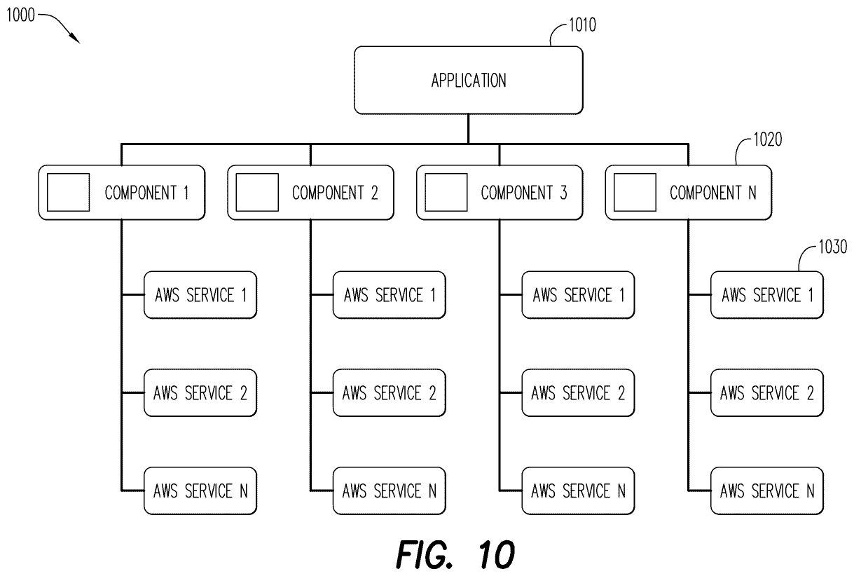

At S910, the application component types for the application identified in S218 are retrieved. For each application component type, one or more web services (e.g., AWS®) used to implement the component are identified in S912. FIG. 10 illustrates a non-exhaustive example 1000 of the application 1010, the application component types 1020 and one or more web services 1030. A Total Cost of Operation (TCO) is calculated for each web service in S914. Pursuant to embodiments, TCO (web service)=ongoing annual cost+ongoing licensing cost. Then, in S916, the TCO for each component is calculated for refactoring. Pursuant to embodiments TCO (Component)=Sum of TCO of web services used by the component. Next, in S918, the TCO for each component is calculated for rehosting/re-platforming. It is noted that the order of S916 and S918 may be reversed, may occur at the same time, or may occur at substantially the same time. Then, in S920, the TCO for the application is determined for refactoring. Next, in S922, the TCO for the application is determined for rehosting/re-platforming. Pursuant to embodiments, TCO (Application)=Sum of Annual TCO of all components+ongoing annual labor cost to maintain the application. To determine the five year TCO for the application by re-factoring or rehosting/re-platforming, the TCO (Application) for refactoring or rehosting/re-platforming, respectively, is multiplied by five. The system may then calculate the five year application investment cost for rehosting/re-platforming as equal to the five year TCO for rehosting/re-platforming plus one time migration cost of rehosting/re-platforming. Similarly, the system may then calculate the five year application investment cost for refactoring as equal to the five year TCO for refactoring plus one time migration cost of refactoring. At S924, the application opportunity cost of rehosting/re-platforming for the four to five years is calculated as being equal to the five year application investment cost of rehosting minus the five year application investment cost of refactoring.

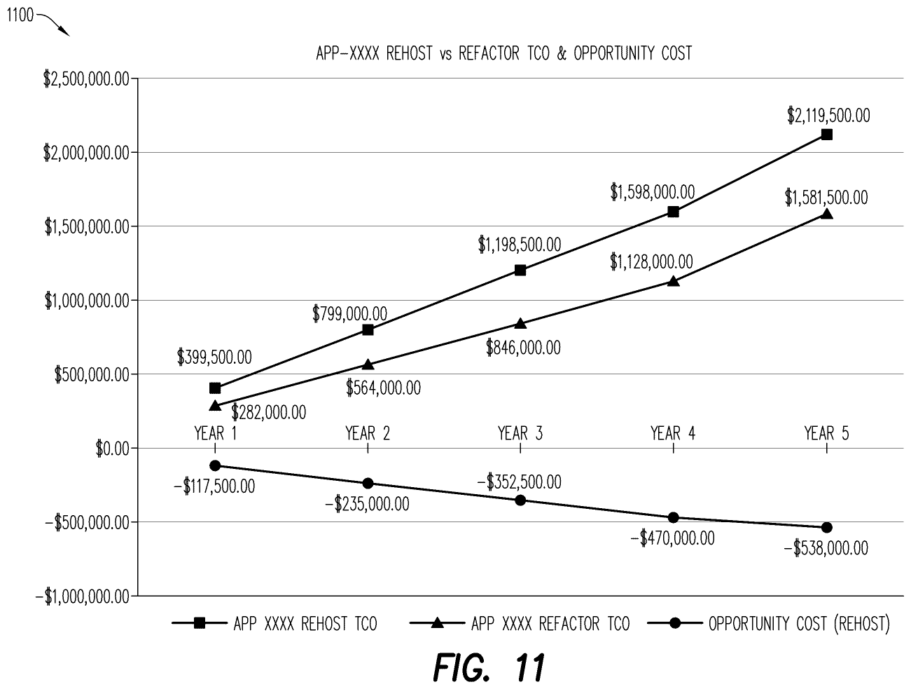

FIG. 11 illustrates a graph 1100 of a non-exhaustive example of a TCO comparison and opportunity cost, as described above with respect to FIGS. 9 and 10. As shown herein, the total cost of operation (TCO) for rehosting the application starts at a higher cost than the TCO for refactoring the application, and remains at a higher cost for each of years two through five. Additionally, the opportunity cost associated with rehosting versus refactoring is an increasing loss for years two through five. In this non-exhaustive example, rehosting the application as compared to modernizing (refactoring) the application comes at a financial loss. Depending on the opportunity costs, the enterprise may rebalance an application portfolio budget and develop funding options to move forward with modernizing the application.

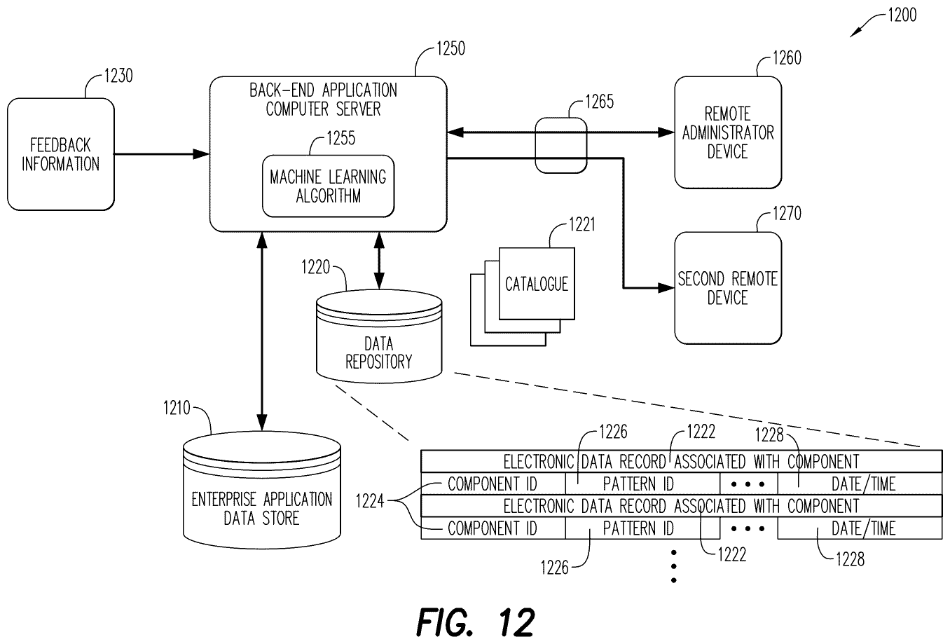

FIG. 12 is a more detailed block diagram of an application modernization framework or system 1200 according to some embodiments. As before, the system 1200 includes a back-end application computer server 1250 that may access information in an enterprise application data store 1210 (e.g., storing a set of electronic records associated with applications that are candidates for modernization). The back-end application computer server 1250 may also utilize information in other data stores, such as a data repository 1220 (e.g., storing a catalogue 1221 that comprises electronic records associated with components 1222, a component identifier 1224, a pattern identifier 1226 and a date/time 1228) and utilize a machine learning algorithm 1255 to view, analyze, and/or update the electronic records. As used herein, the phrase “machine learning algorithm” may refer to any artificial intelligence process trained using historical data and/or outcomes.

The back-end application computer server 1250 may also exchange information with a first remote administrator device 1260 and a second remote administrator device 1270 (e.g., via a firewall 1265). According to some embodiments, an interactive GUI platform of the back-end application computer server 1250 (and, in some cases, feedback information 1230) may be used to further train and improve the machine learning algorithm 1255 and/or the remote administrator devices 1260, 1270. For example, the first remote administrator device 1260 may transmit annotated and/or updated information to the back-end application computer server 1250. Based on the updated information, the back-end application computer server 1250 may adjust data in the enterprise application data store 1210 and/or the data repository 1220 (e.g., information to automatically facilitate with determination of an application as a candidate for modernization) and the change might (or might not) be viewable via the second remote administrator device 1270.

The back-end application computer server 1250 and/or the other elements of the system 1200 might be, for example, associated with a PC, laptop computer, smartphone, an enterprise server, a server farm, and/or a database or similar storage devices. As used herein, devices, including those associated with the back-end application computer server 1250 and any other device described herein, may exchange information via any communication network which may be one or more of a LAN, a MAN, a WAN, a proprietary network, a PSTN, a WAP network, a Bluetooth network, a wireless LAN network, and/or an IP network such as the Internet, an intranet, or an extranet.

The back-end application computer server 1250 may store information into and/or retrieve information from the enterprise application data store 1210 and/or the data repository 1220. The data elements 1210, 1220 may be locally stored or reside remote from the back-end application computer server 1250. As will be described further below, the enterprise application data store 1210 may be used by the back-end application computer server 1250 in connection with an interactive GUI to let an operator or administrator access and/or update electronic records. Although a single back-end application computer server 1250 is shown in FIG. 12, any number of such devices may be included.

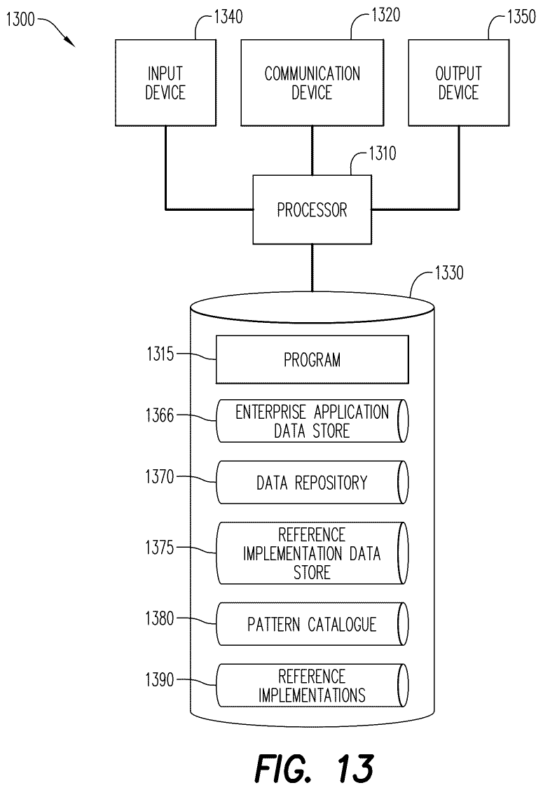

The embodiments described herein may be implemented using any number of different hardware configurations. For example, FIG. 13 illustrates an apparatus 1300 that may be, for example, associated with the systems 100, 1200 described with respect to FIGS. 1 and 12, respectively. The apparatus 1300 comprises a processor 1310, such as one or more commercially available Central Processing Units (“CPUs”) in the form of one-chip microprocessors, coupled to a communication device 1320 configured to communicate via a communication network (not shown in FIG. 13). The communication device 1320 may be used to communicate, for example, with one or more remote administrator devices (e.g., PCs and smartphones), administrator computers, and/or third-party platforms. Note that data exchanged via the communication device 1320 may utilize security features, such as encryption between an emergency responder and an internal network of an insurance company and/or telematics enterprise. The security features might be associated with, for example, web servers, firewalls, and/or PCI infrastructure. The apparatus 1300 further includes an input device 1340 (e.g., a mouse and/or keyboard to enter information about data sources, a cloud computing environment, vendors, etc.) and an output device 1350 (e.g., to output reports regarding modernization performance, summary logs, recommended actions, alerts, etc.).

The processor 1310 also communicates with a storage device 1330. The storage device 1330 may comprise any appropriate information storage device, including combinations of magnetic storage devices (e.g., a hard disk drive), optical storage devices, mobile telephones, and/or semiconductor memory devices. The storage device 1330 stores a program 1315 and/or application modernization framework or application for controlling the processor 1310. The processor 1310 performs instructions of the program 1315, and thereby operates in accordance with any of the embodiments described herein. For example, the processor 1310 may retrieve information from an enterprise application data store 1366 and, based on enterprise application parameters, determine whether the application is a candidate for modernization. For each application identified as a modernization candidate, the processor 1310 may identify the components in the application via a component catalogue and then based on the components, identify an appropriate cloud computing pattern for the application in a pattern catalogue 1380. The processor 1310 then uses the pattern to automatically create a reference implementation of the enterprise application in a cloud computing environment.

The program 1315 may be stored in a compressed, uncompiled and/or encrypted format. The program 1315 may furthermore include other program elements, such as an operating system, a database management system, and/or device drivers used by the processor 1310 to interface with peripheral devices.

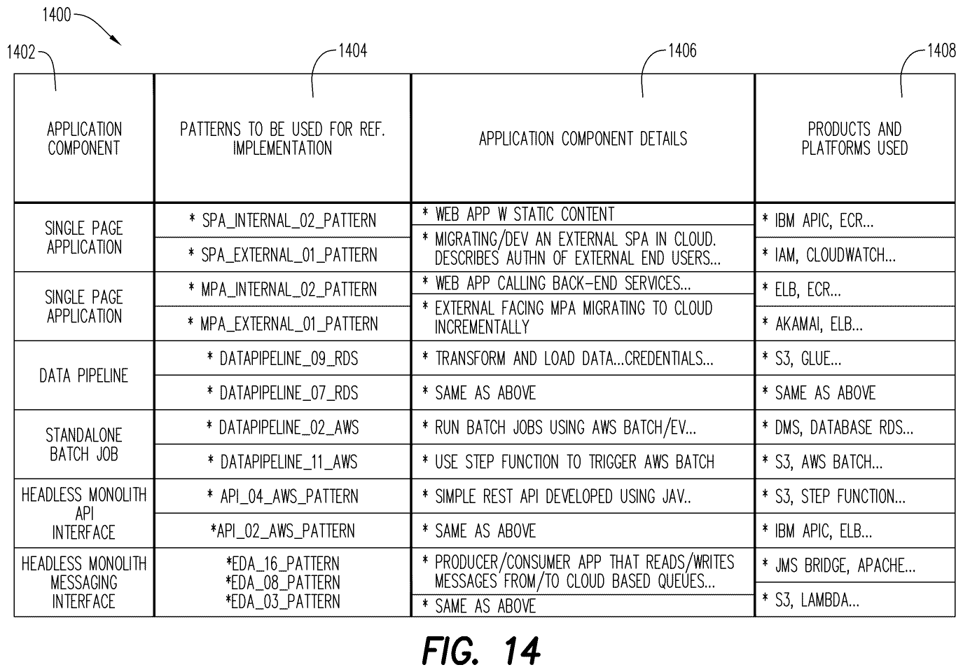

As used herein, information may be “received” by or “transmitted” to, for example: (i) the apparatus 1300 from another device; or (ii) a software application or module within the apparatus 1300 from another software application, module, or any other source. In some embodiments (such as shown in FIG. 13), the storage device 1330 further stores the enterprise application data store 1366 (e.g., associated with on-premises business applications to be automatically migrated), a data repository 1370 (e.g., associated with GITHUB®), a reference implementation data store 1375 (e.g., containing component descriptions), a pattern catalogue 1380 (e.g., containing pattern descriptions), and reference implementation 1390 (e.g., storing items that can be executed in the cloud computing environment). An example of a database that might be used in connection with the apparatus 1300 will now be described in detail with respect to FIG. 14. Note that the database described herein is only an example, and additional and/or different information may be stored therein. Moreover, various databases might be split or combined in accordance with any of the embodiments described herein. For example, the enterprise application data store 1366 and reference implementation data store 1375 might be combined and/or linked to each other within the program 1315.

Referring to FIG. 14, a table 1400 is shown that represents the reference implementation data store 1375 that may be stored at the apparatus 1300 according to some embodiments. The table may include, for example, entries associated with application component types making up an application that is a candidate for modernization. The table may also define fields 1402, 1404, 1406, 1408 for each of the entries. The fields 1402, 1404, 1406, 1408 may, according to some embodiments, specify: an application component identifier 1402, patterns to be used for the reference implementation 1404 for that application component identifier, application component details 1406 and products and platforms used with the application component 1408. The reference implementation data store 1375 may be created and updated, for example, based on information electrically received from various data sources (e.g., including when a new application component type is identified) that are associated with a business such as an insurance provider.

The enterprise application component identifier 1402 may be, for example, a unique alphanumeric code associated with components forming an on-premises business application to be migrated to a cloud computing environment. The patterns to be used for reference implementation 1404 might indicate which patterns should be used for this particular component for modernization. The application component details 1406 might indicate additional information for the particular pattern. The products and platforms used 1408 might indicate the products and platforms used with the particular pattern for the modernization of the respective component.

Thus, embodiments may provide an automated and efficient way to determine when and how to modernize an application for migration to a cloud computing environment in a way that provides fast and useful results (and that allows for flexibility and effectiveness when implementing those results). Cloud adoption might be accelerated because migration teams don't need to “reinvent the wheel” to figure out which applications to modernize and how to modernize the applications for migration to the cloud. Embodiments may provide a consistent approach to cloud application development and deployment using highly reusable reference architecture patterns and their reference implementations (which may substantially reduce operational costs).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of enterprises and business applications, embodiments may instead be associated with other types of enterprises and applications in addition to and/or instead of those described herein (e.g., financial institutions, universities, etc.). Similarly, although certain types of parameters were described in connection some embodiments herein, other types of parameters might be used instead of, or in addition to, those mentioned.

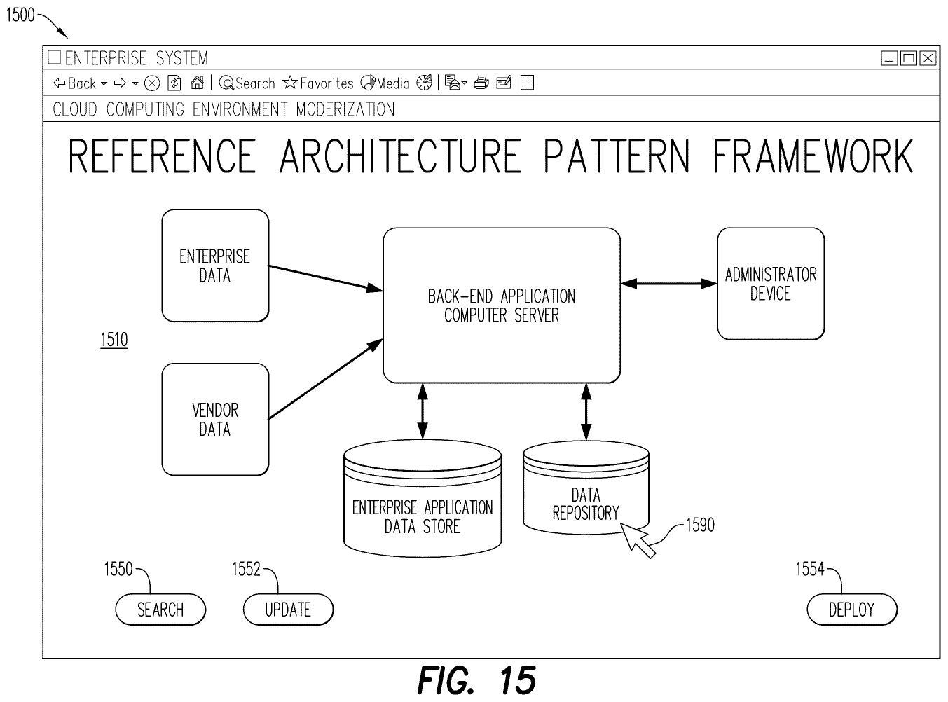

Note that the displays and devices illustrated herein are only provided as examples, and embodiments may be associated with any other types of interfaces. For example, FIG. 15 is an administrator display 1500 including graphical representations of elements 1510 of an application modernization framework. Selection of a portion or element of the display 1500 might result in the presentation of additional information about that portion or device (e.g., a popup window presenting a more detailed view of mappings or other specifics of the system implementation) or let an administrator enter or annotate additional information about application modernization framework (e.g., based on his or her experience and expertise). Selection of a “Search” icon 1550 (e.g., by touchscreen or computer mouse pointer 1590) might cause the system or platform to search a catalogue of patterns looking for a pattern to facilitate migration. Selection of an “Update” icon 1552 might cause the system to refresh or store newly entered parameters (e.g., a data repository location or a cloud account identifier), and selection of an “Deploy” icon 1554 might cause the system or platform to automatically move a reference implementation to a cloud environment.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed is:

1. A cloud modernization system implemented via a back-end application computer server, comprising:
(a) an enterprise application data store that contains electronic records associated with a plurality of enterprise applications, each electronic record including an electronic record identifier and at least one enterprise application parameter;
(b) a data repository storing a catalogue of cloud computing patterns;
(c) the back-end application computer server, coupled to the enterprise application data store and the data repository, including:
a computer processor, and
a computer memory, coupled to the computer processor, storing instructions that, when executed by the computer processor, cause the back-end application computer server to:
(i) retrieve information from the enterprise application data store for a selected first electronic record for a first application;
(ii) based on enterprise application parameters, automatically generate a modernization effort score representing a complexity of modernizing the first application;
(iii) tag the first application as one of: a modernization candidate, a re-platform candidate, and a re-host candidate, the tagging based on the modernization effort score;
(iv) in a case the first application is identified as the modernization candidate:
identify an appropriate cloud computing pattern in the catalogue of cloud computing patterns for the first application;
automatically create, using the identified cloud computing pattern, a reference implementation of the first application in a cloud computing environment;
create a target modernization template for re-factoring the first application, the target modernization template including starter code and structure for the reference implementation; and
(d) a communication port coupled to the back-end application computer server to facilitate a transmission of data with a remote administrator device to support an interactive graphical interface display via a distributed communication network.

2. The system of claim 1, wherein the first application is tagged as one of the modernization candidate, the re-platform candidate and the re-host candidate based on a comparison of the modernization effort score to a plurality of thresholds.

3. The system of claim 1, wherein the modernization effort score is an average of a plurality of modernization effort scores calculated for a respective plurality of criteria.

4. The system of claim 1, wherein patterns are associated with at least one of: (i) a Single Page Application (“SPA”), (ii) a Multi-Page Application (“MPA”), (iii) an Event Driven Architecture (“EDA”), and (iv) microservices.

5. The system of claim 1, further comprising instructions that, when executed by the computer processor, cause the back-end application computer server to:
execute a rehost versus refactoring analysis.

6. The system of claim 5, wherein the rehost versus refactoring analysis is based on a flag indicator.

7. The system of claim 6, wherein the rehost versus refactoring analysis includes calculation of a component value for each component type of the first application.

8. The system of claim 1, further comprising instructions that, when executed by the computer processor, cause the back-end application computer server to:
generate a modernization maturity score representing a stage of modernization of the target modernization template.

9. The system of claim 1, wherein the target modernization template structure includes an Infrastructure as Code (IaC), and a Continuous Integration/Continuous Deployment (CI/CD) pipelines.

10. The system of claim 1, further comprising instructions that, when executed by the computer processor, cause the back-end application computer server to initiate migration of the first application.

11. A computerized cloud modernization method implemented via a back-end application computer server, comprising:
retrieving, by a computer processor of the back-end application computer server, information from an enterprise application data store for a selected first electronic record for a first application;
based on enterprise application parameters, automatically generating a modernization effort score representing a complexity of modernizing the first application;
tagging the first application as one of: a modernization candidate, a re-platform candidate, and a re-host candidate, the tagging based on a comparison of the modernization effort score to a plurality of thresholds;
in a case the first application is identified as the modernization candidate:
identifying an appropriate cloud computing pattern in a catalogue of cloud computing patterns for the first application;
automatically creating, using the identified cloud computing pattern, a reference implementation of the first application in a cloud computing environment; and
creating a target modernization template for refactoring the first application, the target modernization template including starter code and structure for the reference implementation.

12. The method of claim 11, wherein the modernization effort score is an average of a plurality of modernization effort scores calculated for a respective plurality of criteria.

13. The method of claim 11, wherein patterns are associated with at least one of: (i) a Single Page Application (“SPA”), (ii) a Multi-Page Application (“MPA”), (iii) an Event Driven Architecture (“EDA”), and (iv) microservices.

14. The method of claim 11, further comprising:
executing a rehost versus refactoring analysis including calculation of a component value for each component type of the first application.

15. The method of claim 14, wherein the execution of the rehost versus refactoring analysis is based on a flag indicator.

16. A non-transitory, computer-readable medium storing instructions, that, when executed by a processor, cause the processor to perform a cloud modernization method implemented via a back-end application computer server, the method comprising:
retrieving, by a computer processor of the back-end application computer server, information from an enterprise application data store for a selected first electronic record for a first application;
based on enterprise application parameters, automatically generating a modernization effort score representing a complexity of modernizing the first application;
tagging the first application as one of: a modernization candidate, a re-platform candidate, and a rehost candidate, the tagging based on the modernization effort score;
in a case the first application is identified as the modernization candidate:
identifying an appropriate cloud computing pattern in a catalogue of cloud computing patterns for the first application;
automatically creating, using the identified cloud computing pattern, a reference implementation of the first application in a cloud computing environment; and
creating a target modernization template for re-factoring the first application, the target modernization template including starter code and structure for the reference implementation.

17. The medium of claim 16, wherein the first application is tagged as one of the modernization candidate, the re-platform candidate and the rehost candidate based on a comparison of the modernization effort score to a plurality of thresholds.

18. The medium of claim 16, further comprising:
generating a modernization maturity score representing a stage of modernization of the target modernization template.

19. The medium of claim 16, wherein the target modernization template includes an Infrastructure as Code (IaC), a Continuous Integration/Continuous Deployment (CI/CD) workflow and a starter code.

20. The medium of claim 16, further comprising:
initiating migration of the first application.
